(19) United States
(12) Patent Application Publication
(10) Pub. No.: US 2012/0248065 A1
(43) Pub. Date: Oct. 4, 2012

(54) METHOD FOR FORMING A PATTERN

(76) Inventors: Yoshihisa KAWAMURA, Yokohama-shi (JP); Shinichi Ito, Yokohama-shi (JP)

(21) Appl. No.: 13/424,837

(22) Filed: Mar. 20, 2012

(30) Foreign Application Priority Data
Mar. 30, 2011 (JP) 2011-076443

(51) Int. Cl. B05D 5/00; B05D 3/06; B05D 3/10; B05D 3/12

(52) U.S. Cl. 216/66; 427/553; 427/535

(57) ABSTRACT

According to one embodiment, a pattern forming methoo is disclosed. A film is formed on a substrate to be processed. A gaps is formed in a surface of the film. A photo-curable imprinting agent is supplied on the film surface in which the gaps are formed. The agent is contacted with a template including a concave pattern. The contacting is configured to fill the concave pattern with the agent. Light is applied to the agent while the agent is contacted with the template, wherein the agent is cured by the light. The template is separated from the substrate, wherein a pattern of the cured agent is formed on the substrate.

### CROSS-REFERENCE TO RELATED APPLICATIONS

This application is based upon and claims the benefit of priority from prior Japanese Patent Application No. 2011-076443, filed Mar. 30, 2011, the entire contents of which are incorporated herein by reference.

### FIELD

Embodiments described herein relate generally to a pattern forming method used in a semiconductor device manufacturing process, hard disk manufacturing process, photo array manufacturing process or the like.

### BACKGROUND

Recently, in a fabrication of devices such as semiconductor devices, HDDs and photo arrays, an imprinting method, which transfer a mold (template) of an original plate onto a substrate to be processed, has been attracting attention. In the imprinting method, first, a template having formed a concave-shaped pattern thereon is pressed down onto filling material applied on a substrate such that the template pattern is filled with the filling material, and after the filling material is cured, the template is separated from the filling material to form a pattern on the substrate.

However, in the pattern forming which uses this imprinting method, the filling rate of the filling material becomes low in some cases.

### BRIEF DESCRIPTION OF THE DRAWINGS

FIG. 1 is a schematic view of an imprint apparatus for implementing a pattern forming method;

FIGS. 2A, 2B, 2C, 2D, 2E, 2F, 2G and 2H are cross-sectional views for illustrating a pattern forming method according to a first embodiment; and

FIGS. 3A, 3B, 3C, 3D, 3E, 3F, 3G and 3H are cross-sectional views for illustrating a pattern forming method according to a second embodiment.

### DETAILED DESCRIPTION

Embodiments are explained below with reference to the drawings.

In general, according to one embodiment, a method for forming a pattern is disclosed. The method includes forming a film on a substrate to be processed. The method further includes forming gaps in a surface of the film. The method further includes supplying a photo-curable imprinting agent on the film surface in which the gaps are formed. The method further includes contacting the photo-curable imprinting agent with a template. Here, the template includes a concave pattern, and the contacting is configured to fill the concave pattern with the photo-curable imprinting agent. The method further includes applying light to the photo-curable imprinting agent while the photo-curable imprinting agent is being contacted with the template. Here, the photo-curable imprinting agent is cured by the light applied thereto. The method further includes separating the template from the substrate. As a result a pattern of the cured photo-curable imprinting agent is formed on the substrate.

According to another embodiment, a method for forming a pattern is disclosed. The method includes forming a first film on a substrate to be processed. The method further includes forming a second film on the first film. The method further includes forming gaps in a surface of the second film. The method further includes supplying a photo-curable imprinting agent on the surfaces of the first and second films. The method further includes contacting the photo-curable imprinting agent with a template. Here, the template includes a concave pattern, and the contacting is configured to fill the concave pattern with the photo-curable imprinting agent. The method further includes applying light to the photo-curable imprinting agent while the photo-curable imprinting agent is being contacted with the template. Here, the photo-curable imprinting agent is cured by the light applied thereto. The method further includes separating the template from the substrate. As a result, a pattern of the cured photo-curable imprinting agent is formed on the substrate.

### First Embodiment

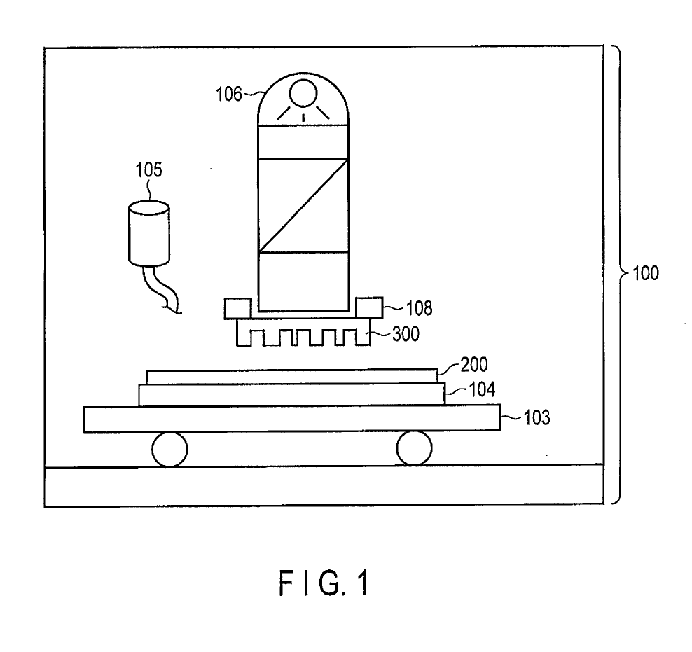

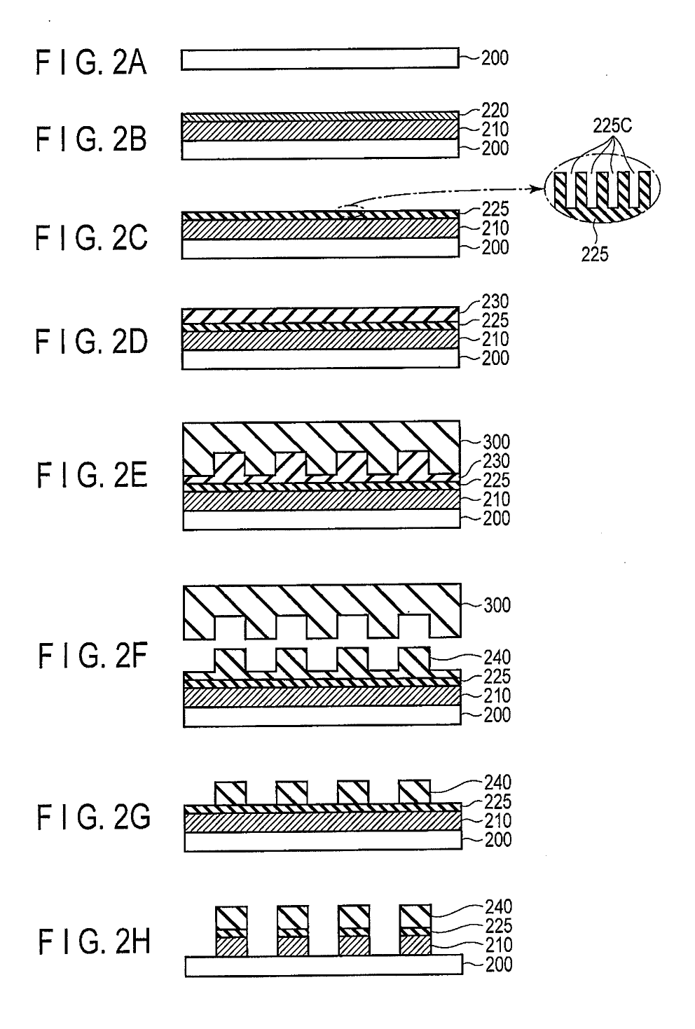

A pattern forming method by imprinting method in accordance with a first embodiment is explained with reference to FIG. 1 and FIGS. 2A to 2H.

First, an imprint apparatus used for the pattern forming method in accordance with the present embodiment is schematically explained. FIG. 1 is a schematic configuration view of the imprint apparatus used in the pattern forming method in accordance with the present embodiment.

An imprint apparatus 100 comprises a substrate chuck 104 configured to fix a substrate 200 (substrate to be processed) with a main surface (pattern forming surface) thereof set up, a substrate stage 103 configured to move the substrate chuck 104 three-dimensionally, a photo-curable imprinting agent coating module 105 for selectively supplying a photo-curable imprinting agent (filling material) onto the substrate 200, a template holding module 108 for holding an imprinting template 300 having a concave pattern formed thereon with a concave pattern forming surface thereof set down, and a light source (for example, UV lamp) 106 that applies light used for curing the photo-curable imprinting agent via the template 300. The imprinting template 300 is formed by, for example, forming a concave pattern in a transparent quartz substrate by plasma etching. The substrate 200 and template 300 are set in the apparatus when the apparatus 100 of FIG. 1 is used and are not included in the configuration of the apparatus 100.

Next, the pattern forming method using the imprint apparatus is explained with reference to FIGS. 2A to 2H. FIGS. 2A to 2H are cross-sectional views for illustrating the pattern forming method in accordance with the present embodiment.

First, as shown in FIG. 2A, a substrate 200 of the present embodiment is prepared. The substrate 200 is a silicon wafer or the like. An inter-level insulating film such as a silicon oxide film, a conductive film such as a polysilicon or copper wiring or the like may be formed on a processing surface of the substrate 200. Next, as shown in FIG. 2B, a first spin•on•glass (SOG) film 210 is formed to a film thickness of approximately 40 nm on the substrate 200 by spin coating method. Further, on the surface of the structure, a second SOG film 220 having a higher carbon content in comparison with the first SOG film 210 is formed to a film thickness of approximately 2 nm.

Further, as shown in FIG. 2C, the surface of the second SOG film 220 is exposed to oxygen plasma to remove a hydrocarbon portion of the second SOG film 220. Thereby, fine gaps, for example, cracks can be formed in the second SOG film 220 and thus a second SOG film 225 having cracks 225C formed on the surface thereof is formed. Here, for example, the gaps such as the cracks 225C are formed in a slit form with the width of 1 nm or less but may be formed in a hole form. By setting the width of the gap to 1 nm or less, it can be effectively prevented that a photo-curable imprinting agent that will be described later penetrates into the second SOG film 220. The gaps can also be formed by colliding Ar against the surface of the second SOG film 220 by ion-milling method.

Thereafter, the substrate 200 is moved into the apparatus 100 shown in FIG. 1 and a pattern is formed on the substrate 200 by use of imprinting lithography. A photo-curable imprinting agent that is cured by applying light thereto, for example, epoxy resin is used as a filling material. As the photo-curable imprinting agent other than epoxy resin, photo-curable imprinting agent which is generally used in imprinting lithography and is formed of material having etching resistance at the time of etching process for the SOG film, for example, acryl-series photo-curable resin may be used.

Then, as shown in FIG. 2D, the substrate 200 is held by the substrate chuck 104 (not shown in the drawing) in the imprint apparatus 100 with the main surface thereof set up, the substrate 200 is moved to a portion immediately below the photo-curable imprinting agent coating module 105 (not shown in the drawing) and the photo-curable imprinting agent coating module 105 is scanned over a pattern forming region on the second SOG film 225 to coat and form a photo-curable imprinting agent 230. The photo-curable imprinting agent 230 may be coated and formed in a liquid drop form on the second SOG film 225.

Since the crack portion (gap) of the surface of the second SOG film 225 is formed with hydrophile property by the plasma process, a hydrophobic photo-curable imprinting agent 230 containing a hydrophobic component does not penetrate into the cracks formed in the surface of the second SOG film 225.

Further, as shown in FIG. 2E, the substrate stage 103 and the template 300 are relatively moved to contact the photo-curable imprinting agent 230 formed on the substrate 200 with the concave pattern surface of the template 300. At this time, the photo-curable imprinting agent 230 is filled in the concave pattern of the template 300 by a capillary action since it has fluidity.

In the conventional imprinting lithography, in the initial process of filling, an atmosphere existing between the concave pattern of the template and the photo-curable imprinting agent is introduced into a space of the concave pattern, the filling pressure rises due to the capillary phenomenon and the introduced atmosphere is compressed. Since the conventional process of filling the photo-curable imprinting agent is performed while air in the concave pattern is being compressed, a relatively long time is required for complete filling.

According to the pattern forming method of the present embodiment, a part of an atmosphere introduced in the space of the concave pattern is diffused into the photo-curable imprinting agent 230 at the time of filling the photo-curable imprinting agent 230 in the concave pattern of the template 300 and can be discharged into a space of the second SOG film 225 under the photo-curable imprinting agent 230. Therefore, the photo-curable imprinting agent 230 can be easily filled in the concave pattern of the template 300 and the filling time can be greatly reduced.

After the photo-curable imprinting agent 230 is filled in the template pattern, the substrate 200 and template pattern are aligned. After the alignment, light from the light source 106 (not shown in the drawing) is applied to the photo-curable imprinting agent 230 via the template 300 to cure the photo-curable imprinting agent 230. As the light source 106, a lamp that emits light in the wavelength range of 300 nm to 400 nm is used. It is required for the wavelength of the light source 106 to include the wavelength that permits the photo-curable imprinting agent 230 to absorb light and exhibit a cross-linking reaction and, for example, one of a high pressure mercury lamp, tungsten lamp, UV-LED and ultraviolet laser can be selected according to the absorbing range of the photo-curable imprinting agent 230.

Next, as shown in FIG. 2F, the substrate stage 103 (not shown in the drawing) and the template 300 are relatively moved to separate the template 300 from the photo-curable imprinting agent 230 and a photo-curable imprinting agent pattern 240 is formed on the substrate 200.

Subsequently, as shown in FIG. 2G, the photo-curable imprinting agent pattern 240 is etched back by using oxygen plasma and a portion of the photo-curable imprinting agent pattern 240 that is left behind as a thin film on the second SOG film 225 is removed to expose a part of the second SOG film 225.

Further, as shown in FIG. 2H, an anisotropic etching process using phlorocarbon-series gas and oxygen gas is performed using the photo-curable imprinting agent pattern 240 as a mask to remove a portion of the second SOG film 225 and a portion of first SOG film 210.

In the pattern forming method of the present embodiment, a laminated film is formed by sequentially laminating the first SOG film 210 and second SOG film 220 on the substrate 200. However, if shallow cracks can be formed in an SOG film, a single-layered SOG film may be formed on the substrate 200 and shallow cracks may be formed in the surface of the SOG film.

### Second Embodiment

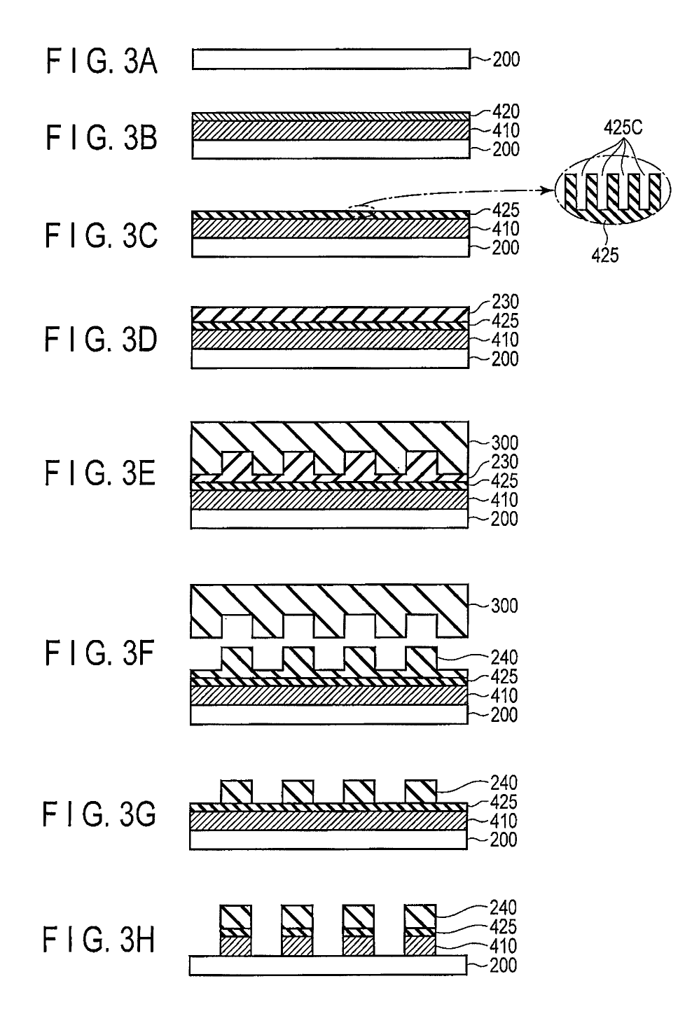

A pattern forming method by imprinting method in accordance with a second embodiment is explained with reference to FIG. 1 and FIGS. 3A to 3H.

The pattern forming method of the present embodiment using the imprint apparatus 100 shown in FIG. 1 is explained with reference to FIGS. 3A to 3H.

First, as shown in FIG. 3A, a substrate 200 (substrate to be processed) is prepared. Like the substrate explained in the first embodiment, the substrate 200 is a silicon substrate. Various insulating films and the like are formed on the surface thereof.

Next, as shown in FIG. 3B, a first coat-type carbon film 410 is formed to a film thickness of approximately 200 nm on the substrate 200 by spin coating method. Further, on the surface of the structure, a second coat-type carbon film 420 having higher tensile stress in comparison with the first coat-type carbon film 410 is formed to a film thickness of approximately 10 nm.

Further, as shown in FIG. 3C, the surface of the second coat-type carbon film 420 is exposed to fluorine plasma to form fine gaps, for example, cracks with slit width of 1 nm or less in the second coat-type carbon film 420 and thus a second coat-type carbon film 425 having cracks 425C is formed. Here, for example, the gaps such as the cracks 425C are formed in a slit form with the width of 1 nm or less but may be formed in a hole form. By setting the width of the gap to 1 nm or less, it can be effectively prevented that a photo-curable imprinting agent that will be described later penetrates into the second coat-type carbon film 420.

The second coat-type carbon film 420 is a film that includes hydrogen and whose hydrogen content is lower than carbon content. By subjecting the surface of the second carbon film 420 to a plasma process by using fluorocarbon-series etching gas, hydrogen in the surface of the carbon film 420 is replaced by fluorine and the volume of the carbon film 420 expands. Gaps can be formed in the carbon film 420 by expansion of the volume.

Subsequently, as shown in FIG. 3D, the substrate 200 is moved to the imprint apparatus 100 shown in FIG. 1 and imprinting lithography is performed.

As a photo-curable imprinting agent (filling material) that fills the concave pattern of the template 300, siloxane-series resin is used. Resin that can be used as a photo-curable imprinting agent in the present embodiment is not limited to siloxane-series resin, and another photo-curable imprinting agent can be used if it is a photo-curable imprinting agent having a selective etching ratio with respect to the first and second coat-type carbon films.

First, after the substrate 200 is held on the substrate chuck 104 (not shown in the drawing) with the main surface thereof set up, the substrate 200 is moved to a portion directly below photo-curable imprinting agent coating module 105 and a photo-curable imprinting agent 430 is coated and formed in a pattern forming region of a second coat-type carbon film 425 on the substrate 200. The photo-curable imprinting agent 430 is coated by scanning the photo-curable imprinting agent coating module 105. Further, the photo-curable imprinting agent 430 can be coated in a liquid drop form.

Since the crack portion (gap) formed in the surface of the second coat-type carbon film 425 is formed with hydrophobic property, a hydrophilic siloxane-series photo-curable imprinting agent 430 containing a hydrophilic component does not penetrate into cracks formed in the surface of the second coat-type carbon film 425.

Further, as shown in FIG. 3E, a substrate stage 103 (not shown in the drawing) and the template 300 are relatively moved to contact the photo-curable imprinting agent 430 formed on the substrate 200 with the concave pattern surface of the template 300. At this time, the photo-curable imprinting agent 430 is filled into the concave pattern of the template 300 by a capillary action since it has fluidity.

According to the pattern forming method of the present embodiment, a part of an atmosphere introduced in the space of the concave pattern is diffused into the photo-curable imprinting agent 230 at the time of filling the photo-curable imprinting agent 230 in the concave pattern of the template 300 and can be discharged into a space of the second coat-type carbon film 425 under the photo-curable imprinting agent 230. Therefore, the photo-curable imprinting agent 230 can be easily filled into the concave pattern of the template 300 and the filling time can be greatly reduced.

After the photo-curable imprinting agent 230 is filled into the template pattern, the substrate 200 and template pattern are aligned. After the alignment, light from a light source 106 (not shown in the drawing) is applied to the photo-curable imprinting agent 230 via the template 300 to cure the photo-curable imprinting agent 230. As the light source 106, a lamp that emits light in the wavelength range of 300 nm to 400 nm is used. It is required for the wavelength of the light source 106 to include the wavelength that permits the photo-curable imprinting agent 230 to absorb light and exhibit a cross-linking reaction and, for example, one of a high pressure mercury lamp, tungsten lamp, UV-LED and ultraviolet laser can be selected according to the absorbing range of the photo-curable imprinting agent 230.

Next, as shown in FIG. 3F, the substrate stage 103 (not shown in the drawing) and the template 300 are relatively moved to separate the template 300 from the photo-curable imprinting agent 230 and a photo-curable imprinting agent pattern 240 is formed on the substrate 200.

Subsequently, as shown in FIG. 3G, the photo-curable imprinting agent pattern 240 is etched back by using fluorine plasma and a portion of the photo-curable imprinting agent pattern 240 that is left behind as a thin film on the second coat-type carbon film 425 is removed to expose a part of the second coat-type carbon film 425.

Further, as shown in FIG. 3H, an anisotropic etching process using fluorine gas and oxygen gas is performed using the photo-curable imprinting agent pattern 240 as a mask to remove a portion of the second coat-type carbon film 425 and expose a part of the first coat-type carbon film 410. Subsequently, an anisotropic etching process is performed by changing etching gas to phlorocarbon gas and oxygen gas and the exposed part of the first coat-type carbon film 410 is removed using the photo-curable imprinting agent pattern 240 as a mask.

In the pattern forming method of the present embodiment, a laminated film is formed by sequentially laminating the first carbon film 410 and second carbon film 420 on the substrate 200. However, if shallow cracks can be formed in a carbon film, a single-layered carbon film may be formed on the substrate 200 and shallow cracks may be formed in the surface of the carbon film.

The pattern forming methods of the above two embodiments can be used as a pattern forming method in a semiconductor device manufacturing process, hard disk manufacturing process and photoarray manufacturing process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for forming a pattern comprising:
forming a film on a substrate to be processed;
forming gaps in a surface of the film;
supplying a photo-curable imprinting agent on the film surface in which the gaps are formed;
contacting the photo-curable imprinting agent with a template, the template comprising a concave pattern, and the contacting being configured to fill the concave pattern with the photo-curable imprinting agent;
applying light to the photo-curable imprinting agent while the photo-curable imprinting agent is being contacted with the template, wherein the photo-curable imprinting agent is cured by the light applied thereto; and
separating the template from the substrate, wherein a pattern of the cured photo-curable imprinting agent is formed on the substrate.

2. The method according to claim 1, wherein the gap has hydrophile property and the photo-curable imprinting agent includes a hydrophobic component.

3. The method according to claim 1, wherein the gap has hydrophobic property and the photo-curable imprinting agent includes a hydrophilic component.

4. The method according to claim 1, wherein the gaps are formed by exposing the film to plasma.

5. The method according to claim 1, wherein the gaps are formed by subjecting the film to an ion-milling process.

6. The method according to claim 1, wherein the film is a spin•on•glass film.

7. The method according to claim 1, wherein the film is a coat-type carbon film.

8. The method according to claim 1, wherein width of the gap is not larger than 1 nm.

9. A method for forming a pattern comprising:
forming a first film on a substrate to be processed;
forming a second film on the first film;
forming gaps in a surface of the second film;
supplying a photo-curable imprinting agent on the surfaces of the first and second films;
contacting the photo-curable imprinting agent with a template, the template comprising a concave pattern, and the contacting being configured to fill the concave pattern with the photo-curable imprinting agent;
applying light to the photo-curable imprinting agent while the photo-curable imprinting agent is being contacted with the template, wherein the photo-curable imprinting agent is cured by the light applied thereto; and
separating the template from the substrate, wherein a pattern of the cured photo-curable imprinting agent is formed on the substrate.

10. The method according to claim 9, wherein the gap has hydrophile property and the photo-curable imprinting agent includes a hydrophobic component.

11. The method according to claim 9, wherein the gap has hydrophobic property and the photo-curable imprinting agent includes a hydrophilic component.

12. The method according to claim 9, wherein the gaps are formed by exposing the second film to plasma.

13. The method according to claim 9, wherein the gaps are formed by subjecting the second film to an ion-milling process.

14. The method according to claim 10, wherein the first and second films are formed of a same material.

15. The method according to claim 11, wherein each of the first and second films is a spin•on•glass film and the first film has a higher carbon content than the second film.

16. The method according to claim 10, wherein each of the first and second films is a coat-type carbon film and the first film has higher tensile stress than the second film.

17. The method according to claim 16, wherein the first film contains hydrogen and hydrogen content of the first film is lower than carbon content of the first film.

18. The method according to claim 9, wherein width of the gap is not larger than 1 nm.
